(19) United States
(12) Patent Application Publication
(10) Pub. No.: US 2020/0254489 A1
(43) Pub. Date: Aug. 13, 2020

(54) SCREENING SYSTEM WITH VIBRATION-NODE-ARRANGED VIBRATION SYSTEMS

(71) Applicants: thyssenkrupp Industrial Solutions AG, Essen (DE); thyssenkrupp AG, Essen (DE)

(72) Inventor: Guido LEUSCHEN, Bielefeld (DE)

(73) Assignees: thyssenkrupp Industrial Solutions AG, Essen (DE); thyssenkrupp AG, Essen (DE)

(21) Appl. No.: 16/753,470

(22) PCT Filed: Oct. 8, 2018
(86) PCT No.: PCT/EP2018/077269

§ 371 Date: Apr. 3, 2020

(30) Foreign Application Priority Data
Oct. 13, 2017 (LU) LU100478

(51) Int. Cl. B07B 1/42; B07B 1/28; B07B 1/36

(52) U.S. Cl. CPC B07B 1/42; B07B 1/36; B07B 1/284

(57) ABSTRACT

A screening system for screening material, in particular for screening mineral rock, the system having a screen box, with two outer side walls. At least two vibration systems are arranged on each of the two side walls to excite vibration. The two side walls each have at least two vibration nodes in accordance with a bending mode, at least two crossmembers, which connect the two side walls to one another, at least one screen deck, which is supported on the at least two crossmembers. The two vibration systems on each of the side walls are arranged such that each vibration system is arranged in the region of a vibration node of the respective side wall. The disclosure also relates to a method for screening material to be screened, in particular for screening mineral rock, via a screening system of the aforementioned type.

The invention relates to a screening/sieving system for screening/sieving material to be screened/sieved, in particular for screening mineral rock, the system having a screen box, which comprises two outer side walls, wherein at least two vibration systems are arranged on each of the two side walls to excite vibration and wherein the two side walls each have at least two vibration nodes in accordance with a bending mode, furthermore having at least two crossmembers, which connect the two side walls to one another, and in addition having at least one screen deck, which is supported on the at least two crossmembers. The invention also relates to a method for screening material to be screened, in particular for screening mineral rock, by means of an abovementioned screening system.

A screening system of the type stated at the outset is known from DE 44 17 162 C1, for example. This patent discloses a method and a device for adjusting the vibration behavior of a vibrating conveyor with two opposed unbalance drives driven by electric motor, wherein the position of the unbalance masses relative to one another is adjustable.

The abovementioned screening system has the advantage that each desired vibration angle can be changed continuously during operation, and a vibration angle desired at one time can be maintained, without the material to be conveyed affecting this vibration angle. This is achieved by providing two separate unbalance drives, driven by electric motor, and sensor units assigned to each unbalance drive for determining the real-time angular positions of the unbalance masses, as well as an electronic control system for influencing the current and/or the frequency of the drive motors of the unbalance drives.

In order nevertheless to increase the screening throughput, it is common knowledge that the screening system overall must be enlarged. First of all, this means that a more massive screen is used. However, to be able to excite the more massive screen with the same quality, the vibration drives must be enlarged. The larger vibration drives lead to a considerably larger vibration load acting on the side walls and the crossmembers. Because of the increased mass and vibration loads, the side walls and the crossmembers must therefore also be reinforced. Consequently, an increased screening throughput in a screening system according to the prior art always presupposes more massive screen components, which are more expensive, are more difficult to install and have a higher spatial requirement than the smaller screen components.

It is therefore the object of the invention to provide a screening system of the type stated at the outset, in which the dimensioning of the vibration systems has less influence on the dimensioning of the crossmembers and side walls than in screening systems according to the prior art, wherein the screening system can furthermore be produced in a more advantageous way and should consume less energy in use.

The object is achieved by virtue of the fact that the two vibration systems on each of the side walls are arranged in such a way that each vibration system is arranged in the region of a vibration node of the respective side wall.

A freely vibrating body, in the present case a side wall, has a multiplicity of natural modes with associated natural frequencies. The first bending mode is also referred to as the basic form. The vibration nodes form the positions in the structure which are not deflected by the natural mode. Higher natural modes with an increased frequency may occur, wherein the natural frequencies are very much higher. A natural mode can only be excited if the excitation frequency is close to the natural frequency and is not introduced at the vibration node. The natural frequencies depend on the stiffness and mass of the body or side wall. A lower stiffness reduces the natural frequency. The height of the side walls contributes to stiffness, and it must be taken into account that a vertical elevation with an otherwise identical geometry increases the stiffness and thus also the natural frequency. This is the reason why the conventional way of increasing the stiffness of a side wall consists in increasing the vertical height of the respective side wall. Among scientists, vibration nodes are also known as Bessel points. In the present case, the vibration nodes occur at Bessel points which, in respect of moment, inclination and deflection, represent optimum bearing positions of a uniformly loaded beam, in the present case, for example, a crossmember, at two bearing points.

According to a preferred embodiment of the screening system, the two vibration systems on each of the side walls are arranged in such a way that each vibration system is arranged in the region of a vibration node of the first bending mode of the respective side wall.

As already described, a natural mode can only be excited if the excitation frequency is not introduced at the vibration node. It is therefore in accordance with the teaching of the invention not to have to make the components of the screening system, in particular the crossmembers and the side walls, with considerably more massive dimensions if the formation of the first natural mode is directly prevented. Since the vibration systems are thus arranged in the region of the vibration nodes, this has the effect that the excitation frequency of the vibration systems is not introduced into the side walls so as to form a bending mode.

The further a vibration system is from a vibration node of a side wall, the more the excitation frequency of the vibration system acts on the side wall so as to form a bending mode. It is therefore particularly preferred that at least one, preferably each, vibration system is arranged in direct overlap with the respective vibration node. However, an arrangement of at least one, preferably of each, vibration system in the region of the vibration nodes is also possible. A numerical minimum number is intended by the phrase “at least one”.

In this context, the word “region” preferably describes a maximum radius from the central point of the vibration node, the magnitude of which is less than or equal to 20%, preferably less than or equal to 10%, particularly preferably 0%, of the maximum length of the main extent of the respective side wall, wherein the magnitude of the region is anti-proportional to a maximum radius from the central point of the vibration node, in particular anti-proportional to the maximum length of the main extent of the respective side wall. The indication of anti-proportionality means that, as the magnitude of the maximum length of the main extent of the respective side wall increases, the magnitude of the maximum radius from the central point of the vibration node is reduced. Provision is made here, in particular, for the length of the main extent of the respective side wall to extend along the conveying direction of the material to be screened.

The conveying direction should be interpreted to mean the direction of movement of the material to be screened along the screen deck.

In order to further improve the result of screening, it is envisaged, according to preferred embodiments, that the screen box has at least two, preferably three, screen decks arranged vertically one above the other.

However, the screen box should preferably have no more than six screen decks arranged vertically one above the other. It has been found that a number of more than six screen decks in the screening system under consideration has led to an only insufficient screening result in relation to the expenditure of material.

As a particular preference, the screen decks arranged vertically one above the other are arranged parallel to one another.

According to the teaching of the invention, multiple usage of screen decks is less expensive than conventional screening systems since, in conventional screening systems the necessity of considerably more massive configuration of the side walls for each screen deck has increased considerably. In contrast, the component loading in the screening system according to the invention is significantly reduced, and therefore the side walls do not have to be made considerably more massive with each further screen deck.

In order to be able to match the screening systems particularly well to one another, it is envisaged that the side walls are arranged parallel to one another.

In order to reduce the use of material, provision can be made, as an alternative, for the side walls to be arranged in such a way as to converge, i.e. to taper toward one another.

According to a preferred embodiment of the invention, the two side walls can be arranged in mirror symmetry with respect to a vertical mirror plane extending along a conveying direction. Here, vertical means perpendicular to the horizon. According to this embodiment, the vibration systems can be matched to one another particularly well. The components of the screening system are furthermore loaded as uniformly as possible and hence, as far as possible, gently.

One embodiment is preferably configured in such a way that each vibration system comprises two or more unbalance drives. As a particular preference, each vibration system comprises three or more unbalance drives. In particular, each vibration system can comprise four or more unbalance drives. The vibration angle of the material to be screened can be adjusted with increasing precision with an increasing number of unbalance drives per vibration system.

The vibration angle is interpreted to mean the angle relative to the screen deck at which the material to be screened is thrown by the excitation by means of the vibration systems.

For adjustment of the vibration angle, provision is made, in particular, for each unbalance drive to have a sensor unit for determining a real-time angular position of the unbalance mass.

As a particular preference, provision is made for this purpose for the screen to have a control system which is connected to the unbalance drives in order to adjust phase offsets of the unbalance drives. Thus, the vibration systems designed as unbalance drives are controlled electronically. More precisely, synchronization is preferably performed actively by means of a frequency converter control system.

The reduced loading on the side walls furthermore enables all the crossmembers to be of identical design. This leads to considerably reduced costs because the crossmembers can be produced, transported and installed with identical systems.

Because of the reduced loading, it is furthermore even possible for all the crossmembers to have a hollow profile. This, in turn, reduces the crossmember weight acting on the side walls.

As a particular preference, all the crossmembers can be tubes. The necessity of different crossmembers, in particular the necessity of particularly massive crossmembers in the side wall region with maximum amplitudes of conventional bending modes, is eliminated since the bending modes can now as far as possible not act on the screening system.

Furthermore, the invention relates to a method for screening material to be screened, in particular for screening mineral rock, by means of a screening system according to at least one of the preceding features, wherein the method is characterized by the following method steps: starting the vibration systems designed as unbalance drives, subsequently defining a vibration angle for material to be screened by means of a control system, for which purpose a phase offset of each vibration system is adjusted electronically, if required adapting the vibration angle for material to be screened by means of the control system, for which purpose the phase offset of each vibration system is adapted electronically. It is thereby possible to implement both linear, circular and also elliptical shapes of the vibration movements of the screen box. Depending on the material to be screened or on the changing nature of the material to be screened, e.g. rain-induced humidity, it has been found that it is advantageous if the shapes of the vibration movements can be changed. It is thereby possible to achieve positive energy savings and better screening results.

Further embodiments of the invention are explained in detail with reference to the following description of an exemplary embodiment and the drawings.

In the drawings:

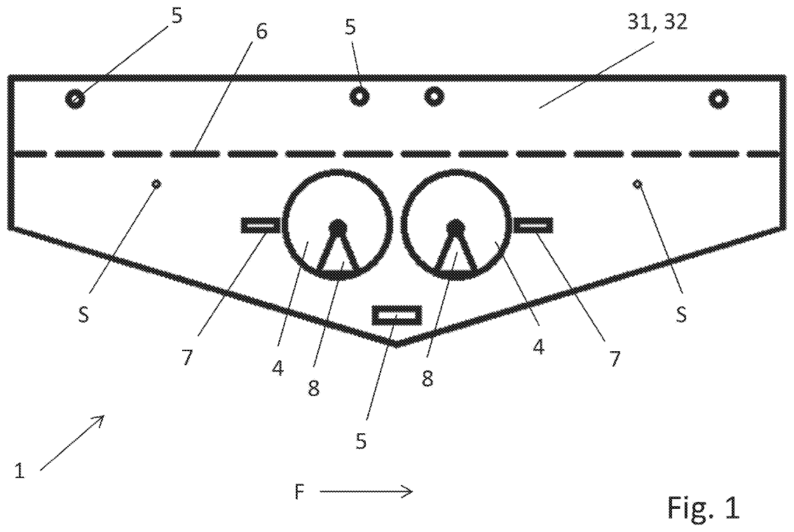

FIG. 1 shows a screening system according to the general prior art in a side view,

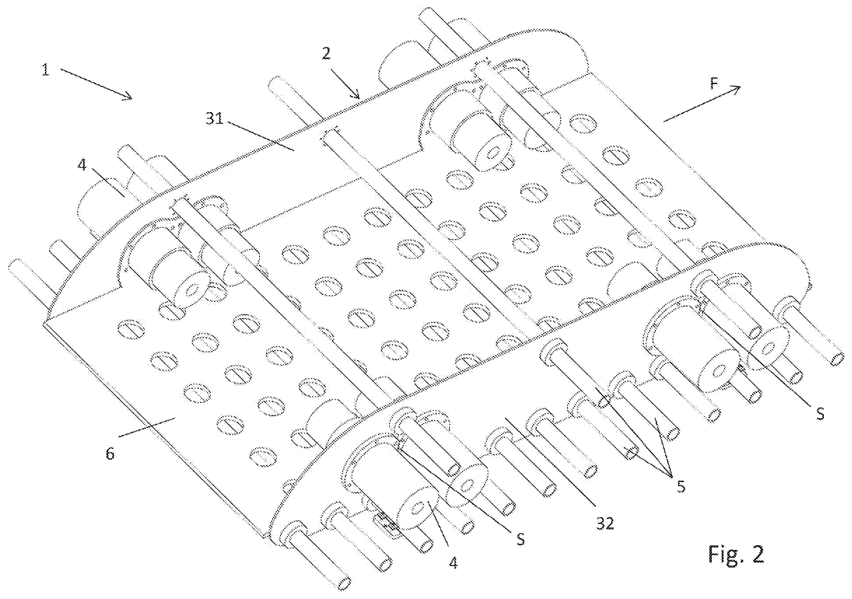

FIG. 2 shows a screening system according to the teaching of the invention in a perspective view,

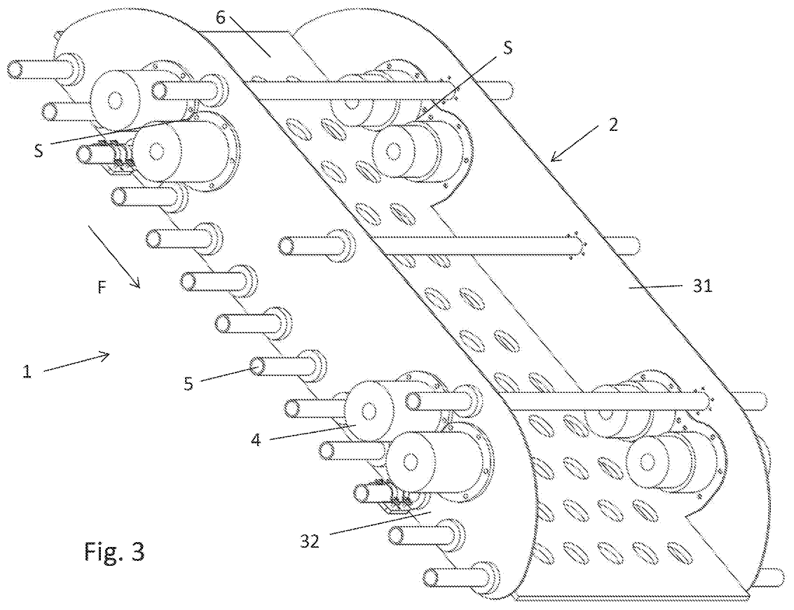

FIG. 3 shows the screening system according to FIG. 2 in an alternative perspective view,

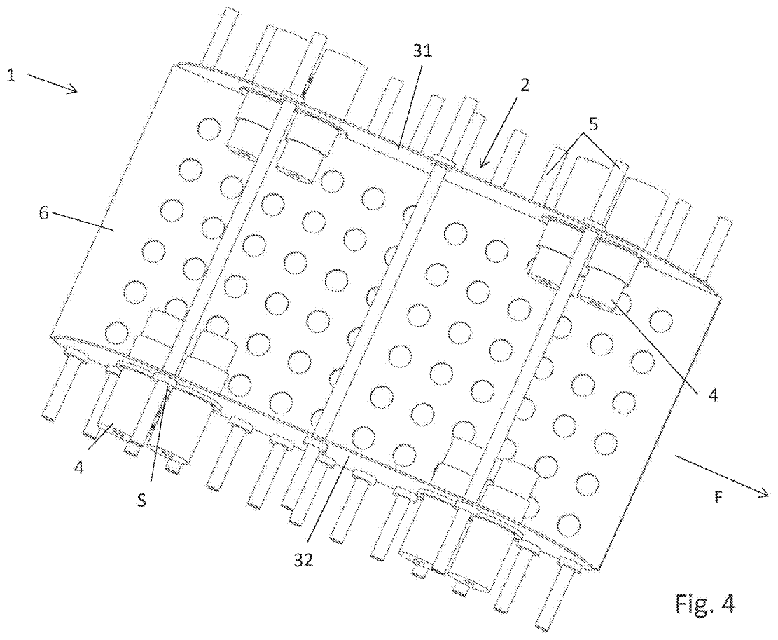

FIG. 4 shows the screening system according to FIGS. 2 and 3 in a perspective plan view,

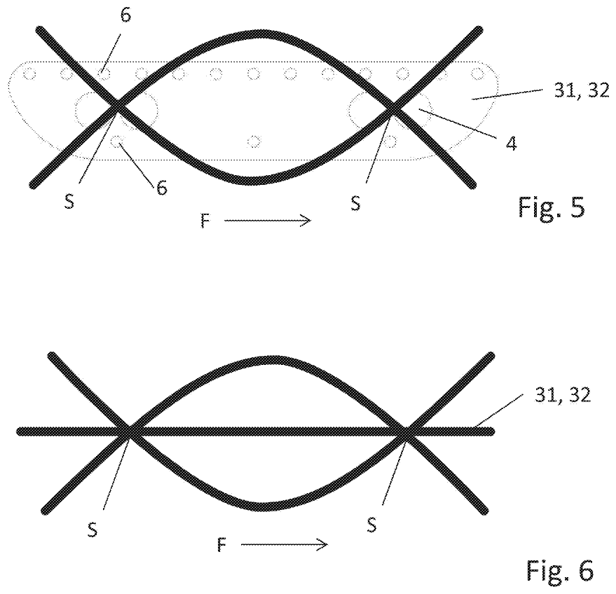

FIG. 5 shows a side wall of the screening system according to the invention in a side view illustrating a vibration node of a first bending mode, and

FIG. 6 shows the vibration nodes of the first bending mode according to FIG. 5 in a simplified illustration.

FIG. 1 shows a side wall (31 or 32) of a screen box (2) of a screening system (1) according to the prior art for screening mineral rock in a side view. Two vibration systems (4) for exciting vibration are arranged on the illustrated side wall (31 or 32). The illustrated side wall (31 or 32) furthermore has two vibration nodes (S) in accordance with a first bending mode. The illustrated side wall (31 or 32) furthermore comprises crossmembers (5), wherein upper crossmembers (5) each have a round profile, and a lower crossmember (5) has a rectangular profile. The different profiles are provided for reasons of stability, wherein more massive crossmembers (5) are preferably dispensed with for reasons of cost and weight. The crossmembers (5) connect the two side walls (31, 32) to one another. Moreover, a screen deck (6) is mounted on the crossmembers (5). Screened mineral rock falls vertically downward through apertures in the screen deck (6). Mineral rock which is larger than the apertures in the screen deck (6) is moved over the screen deck (6) along a conveying direction (F) by the excitation of the vibration systems (4).

FIGS. 2, 3 and 4 show an embodiment according to the invention of a screening system (1) for screening mineral rock, wherein this screening system (1) differs from the screening system (1) shown in FIG. 1, particularly in the arrangement of vibration systems (4).

The screening system (1) shown in FIGS. 2, 3 and 4 has a screen box (2), which comprises two outer side walls (31, 32). The side walls (31, 32) are, in particular, of mirror-symmetrical design, and therefore they do not differ significantly. As illustrated in the present case, the side walls (31, 32) are arranged parallel to one another. In particular, the two side walls (31, 32) are arranged in mirror symmetry with respect to a vertical mirror plane extending along a conveying direction (F).

As partially and only incompletely illustrated in FIGS. 2 to 5, the two side walls (31, 32) each have two vibration nodes (S) of a first bending mode.

The two side walls (31, 32) are connected to one another by a multiplicity of crossmembers (5). In the present case, all the crossmembers (5) are of identical design, namely being designed as tubes with a hollow profile.

It can furthermore be seen in FIGS. 2, 3 and 4 that a screen deck (6) is supported on the crossmembers (5). Screened mineral rock falls vertically downward through apertures in the screen deck (6). Mineral rock which is larger than the apertures in the screen deck (6) is moved over the screen deck (6) along the conveying direction (F) by the excitation of the vibration systems (4).

Two vibration systems (4) for exciting vibration are arranged on each of the two side walls (31, 32), wherein each vibration system (4) consists of two unbalance drives.

It is furthermore illustrated that the two respective vibration systems (4) are arranged in such a way on each of the side walls (31, 32) that each vibration system (4) overlaps a vibration node (S) of the respective side wall (31, 32). Stated more precisely, the two vibration systems (4) are arranged on each of the side walls (31, 32) in such a way that each vibration system (4) is arranged in the region of a vibration node (S) of the first bending mode of the respective side wall (31, 32).

In this context, the word “region” preferably describes a maximum radius from the central point of the vibration node (S), the magnitude of which is less than or equal to 20%, preferably less than or equal to 10%, particularly preferably 0%, of the maximum length of the main extent of the respective side wall (31 or 32), wherein the magnitude of the region is anti-proportional to a maximum radius from the central point of the vibration node (S), in particular anti-proportional to the maximum length of the main extent of the respective side wall (31 or 32).

As a particular preference, the unbalance drives of each vibration system (4) are arranged in such a way that each vibration node (S) is positioned between the unbalance drives.

As a further preference, but not visible in FIGS. 2, 3 and 4, each unbalance drive has an unbalance mass (8). It can furthermore not be seen that each unbalance drive has a sensor unit (7) for determining a real-time angular position of the unbalance mass (8).

In particular, the screen (1) has a control system, not illustrated here, which is connected to the unbalance drives in order to adjust phase offsets of the unbalance drives.

FIGS. 5 and 6 show, in a schematic side view, the side wall (31 or 32) of the screening system (1) according to the invention with illustrated vibration nodes (S) of the first bending mode, wherein FIG. 6 is a simplified illustration of FIG. 5. The bending modes are illustrated in simplified form by means of lines. By means of the arrangement of the vibration systems (4) designed as unbalance drives in the region of the vibration nodes (S), the vibration acting on the side walls (31, 32) can be considerably reduced, and therefore the side walls (31, 32) can be of structurally less massive design, thereby resulting in considerable material and hence also cost savings.

In general, it can be observed that the side view of the screening system according to the prior art shown in FIG. 1 corresponds analogously to the side view of the screening system according to the teaching of the invention shown in FIG. 5, wherein no bending modes are illustrated in FIG. 1.

### LIST OF REFERENCE SIGNS

1 screening system

2 screen box

31 side wall

32 side wall

4 vibration systems

5 crossmembers

6 screen deck

7 sensor unit

8 unbalance mass

F conveying direction

S vibration node

1.-16. (canceled)

17. A screening system for screening material, the system comprising:
a screen box comprising two side walls;
at least two vibration systems arranged on each of the two side walls and configured to excite vibration, wherein the two side walls each have at least two vibration nodes in accordance with a bending mode;
crossmembers connecting the two side walls;
at least one screen deck disposed on the crossmembers;
wherein each of the vibration systems on each of the side walls are respectively disposed in a region of one of the at least two vibration nodes of a respective side wall.

18. The screening system of claim 17 wherein each region of each vibration node has a maximum radius from the central point of the vibration node of less than or equal to 20% of the maximum length of the main extent of the respective side wall.

19. The screening system of claim 17 wherein at least one of the vibration systems directly overlaps with a respective vibration node.

20. The screening system of claim 17 wherein at least one of the vibration systems is arranged in such a way in the region of the vibration node of a respective side wall that the magnitude of the region corresponds to a maximum radius from the central point of the vibration node, the magnitude of which is less than or equal to 20%, or less than or equal to 10% of the maximum length of the main extent of the respective side wall (31 or 32), wherein the magnitude of the region of the maximum radius from the central point of the vibration node is anti-proportional to the maximum length of the main extent of the respective side wall (31 or 32).

21. The screening system of claim 17 wherein the screen box has at least two screen decks arranged vertically one above the other and the screen decks are arranged parallel to one another.

22. The screening system of claim 17 wherein the screen box has no more than six screen decks arranged vertically one above the other and the screen decks are arranged parallel to one another.

23. The screening system of claim 17 wherein the side walls are arranged parallel to one another or converge.

24. The screening system of claim 17 wherein the two side walls are arranged in mirror symmetry with respect to a vertical mirror plane extending along a conveying direction.

25. The screening system of claim 17 wherein each vibration system consists of two, three, four or more unbalance drives.

26. The screening system of claim 25 wherein each unbalance drive has a sensor unit for determining a real-time angular position of an unbalance mass portion of each unbalance drive.

27. The screening system of claim 25 further comprising a control system which is connected to the unbalance drives in order to adjust phase offsets of the unbalance drives.

28. The screening system of claim 17 wherein the two vibration systems on each of the side walls are arranged such that each vibration system is arranged in the region of a v-bration node of the first bending mode of the respective side wall.

29. The screening system of claim 17 wherein all the crossmembers are of identical design.

30. The screening system of claim 17 wherein all the crossmembers have a hollow profile.

31. The screening system of claim 17 wherein all the crossmembers are tubes.

32. A method for screening material to be screened, in particular for screening mineral rock, by means of a screening system comprising a screen box comprising two side walls, at least two vibration systems arranged on each of the two side walls and configured to excite vibration, wherein the two side walls each have at least two vibration nodes in accordance with a bending mode, crossmembers connecting the two side walls, at least one screen deck disposed on the crossmembers, wherein each of the vibration systems on each of the side walls are respectively disposed in a region of one of the at least two vibration nodes of a respective side wall, wherein the method comprises:
starting the vibration systems;
defining a vibration angle for material to be screened by means of a control system of the screening system, for which purpose a phase offset of each vibration system is adjusted electronically; and
adapting, when required, the vibration angle for material to be screened by means of the control system, for which purpose the phase offset of each vibration system is adapted electronically.
